(19) United States
(12) Patent Application Publication
(10) Pub. No.: US 2018/0370016 A1
(43) Pub. Date: Dec. 27, 2018

(54) MARKING-OUT AID

(71) Applicant: Planet GDZ AG, Tagelswangen (CH)

(72) Inventors: Andreas DINTHEER, Illnau (CH); Andreas BRÄNDLE, Hettlingen (CH)

(21) Appl. No.: 15/780,310

(22) PCT Filed: Nov. 24, 2016
(86) PCT No.: PCT/EP2016/078624

§ 371 Date: May 31, 2018

(30) Foreign Application Priority Data
Dec. 1, 2015 (EP) 15197165.2

(51) Int. Cl. B25H 7/00

(52) U.S. Cl. CPC B25H 7/00; E06B 7/36

(57) ABSTRACT

A marking-out aid for application of an installation marking on an object, in particular on a building element, has a first stop surface (20) for the defined contact of the marking-out aid on the object, and also at least one first feeedthrough opening (4) for receiving a marking tool (B). The marking-out aid has a basic body (1) and a first cross bar (2). The al least one first feedthrough opening (4) passes through the basic body (1). The first cross bar (2) is arranged at a first end of the basic body (1) and runs at a right angle to the basic body (1). The first cross bar (2) projects over the basic body (1) on at least one side, wherein that side of the first cross bar (2) which faces away from the basic body (1) forms the first stop surface (20). This marking-out aid is suitable in particular for the installation of finger protection roller screens and finger protection strip covers of doors.

### TECHNICAL FIELD

The present invention relates to a marking-out aid for applying an installation marking to an object, in particular a building part. The marking-out aid is preferably suitable as a means for applying an installation marking for the installation of a finger protection roller blind and/or of a finger protection hinge cover on a door frame and/or on a door wing.

### PRIOR ART

In order to be able install a structural part in a positionally accurate manner on another structural part, in particular on a building part, a measurement is usually firstly taken to establish the place at which the mounting holes are meant to be drilled, or the nails driven in, or the adhesives applied. In order to facilitate the installation, so-called marking-out aids are known. Such marking-out aids allow the application of a marking, usually with a pencil, on the structural part, for example the building part.

DE 195 04 770 discloses a marking-out aid, which can be mounted on a measuring rule. DE 8410488 U shows a marking-out aid in the shape of a right-angled triangle, having a movable grip. DE 10 2007 010 565 describes a marking-out aid in the combination of a slide with a try square.

Marking-out aids should not be constructed too complicatedly, so that they can be used in a simple manner and as free from error as possible. In addition, they should also be usable in cramped spatial conditions. This applies in particular in the field of doors.

It is known to retrofit finger protection devices to doors in order to protect small children from accidents. In one solution variant, the gap between the door frame and that secondary closing edge of the door wing which lies opposite to the hinge side is covered over with a textile protective roller blind, which is fastened on the one side to the door frame and on the other side to the door wing. Furthermore, it is known to protect the hinge side of the door with cover strips, which bridges the spaces between the door hinges.

“On the hinge side” refers to that side of the door wing on which the door hinge, i.e. the frame joint, is disposed. The “opposite hinge side” lies on that side of the door leaf which is opposite thereto. The lock side of the door wing is located at the other end of the door, namely by the door lock and the door handle.

The installation of such finger protection devices must be realized as quickly and cost-effectively as possible. The installation must nevertheless be free from error.

### REPRESENTATION OF THE INVENTION

It is therefore an object of the invention to provide a marking-out aid which is constructed as simply as possible.

The marking-out aid according to the invention for applying an installation marking to an object, in particular a building element, has at least one stop face for the defined contact of the marking-out aid against the object, and at least one first feed-through opening for receiving a marking tool. The marking-out aid has a main body and a first transverse beam.

The at least one first feed-through opening passes through the main body. The first transverse beam is disposed at a first end of the main body and runs at a right angle to the main body, wherein the first transverse beam projects beyond the main body on at least one side, preferably on two, and yet more preferably, on three sides. The first transverse beam forms with its side facing away from the main body a first stop face of the at least one stop face. This first stop face serves preferably for the accurate positioning of the at least one first feed-through opening.

Advantageous is, above all, that the marking-out aid is suitable for applying installation markings for finger protection devices in doors. The marking-out aid according to the invention can be used for markings on the door wing as well as on the door frame (i.e. on the casing).

The marking-out aid can be configured small and can optimally be used also in cramped spatial conditions. Its simple shape allows a one-piece design and thus a cost-effective production. In particular, it can be made of plastic in an injection molding process. Die marking-out aid can also, for instance, consist of wood or metal.

The marking-out aid can be securely held on the main body, while, at the same time, the marking tool, in particular a pencil, can be held with the same hand.

The transverse beam enables a relatively large bearing surface, and thus an accurate positioning of the marking-out aid.

Furthermore, it is advantageous that the marking-out aid can be of relatively small configuration and the marking tool has to be placed into the marking-out aid only once it is used. Moreover, a commercially available pencil can be used as the marking tool without it having to be fastened to the marking-out aid with additional means. The marking-out aid can thus be transported in the trouser pocket or in the jacket pocket of the craftsman and is thus immediately at hand at all times.

Preferably, the first transverse beam projects beyond the main body on at least two sides, whereby it forms a base which is widened in relation to the main body. This increases the accuracy in the application of the marking and prevents tilting of the marking-out aid. The marking-out aid can, moreover, also be used in rotated position.

In a preferred embodiment, the main body is of substantially cuboid configuration and has a front side, a rear side and two end sides. Preferably, the first transverse beam projects beyond the front side and the rear side of the main body. This T-shape with slim design of the main body optimizes the handling and secure holding of the marking-out aid.

In a preferred variant, the first transverse beam projects beyond one of the two end sides of the main body. This increases the size of the first stop face. Moreover, the prominent end side of the transverse beam can serve as a further stop face.

Preferably, in addition to the first stop face, at least one further stop face is present. Preferably, the main body has a second end lying opposite the first end, wherein a second transverse beam is disposed at the second end of the main body and runs at a right angle to the main body and parallel to the first transverse beam. The second transverse beam projects beyond the main body on at least one side, wherein the second transverse beam forms at least one of the further stop faces. The second transverse beam preferably projects beyond the front side and the rear side of the main body, whereby it forms a base which is widened in relation to the main body.

As a result of the configuration of the second transverse beam which offers a second stop face and preferably still further stop faces, the marking-out aid can be used in a variety of ways. In particular, to the different stop faces can be assigned different feed-through openings for the securement of the marking tool. This increases flexibility during use.

The marking-out aid according to the invention can be rotated and turned, in particular in cramped spatial conditions or specific spatial arrangements, until it bears with a suitable stop face against the structural part.

Preferably, the second transverse beam has a flat side which is facing away from the main body and which forms a stop face of the at least one further stop face. This stop face is hereinafter referred to as the second stop face.

Preferably, the second transverse beam has a at least one flat end side, which the main body and which forms a stop face of the at least one further stop face. The end side runs preferably perpendicular to the first stop face and preferably at a right angle to the second stop face. It preferably serves, jointly with the abovementioned second stop face, as a reference for the positioning of second feed-through openings.

Preferably, also the first transverse beam has flat end sides which serve as stop faces.

Preferably, all end sides of the marking-out aid are of flat configuration and serve as stop faces and/or as a straight edge for the line strokes of the marking tool.

In a preferred embodiment, the first and the second transverse beam each have an end side, which end sides are aligned with each other and jointly with an end side of the main body and form a flat fourth stop face. This common flat face, too, can thus form a stop face.

Preferably, the marking-out aid has a double-T-shape, wherein the first transverse beam is on both sides configured shorter than the second transverse beam. The transverse beams, i.e. the T-beams, are preferably equally long, i.e. in mirror symmetry to the main body.

Preferably, the second transverse beam is aligned with both of its end sides with the end sides of the main body, wherein the first transverse beam is aligned only with one end side, and the other end side projects beyond the main body. Preferably, at least all end sides, preferably all surfaces with the exception of the inner sides of the feed-through openings, are of flat configuration, so that they can serve as stop faces. As a result, a marking-out aid which can optimally be used to apply finger protection devices to doors, in particular to apply finger protection roller blinds and hinge covers, is provided. It can, however, also be used as a marking-out aid for other elements and structural parts.

Preferably, the at least one first feed-through opening runs parallel to the first stop face and between two surfaces, running perpendicular to the first stop face, of the main body, i.e. the front and the rear side of the main body. It is preferably arranged at a defined and invariable distance to the first stop face. Preferably, the precise distance to the feed-through opening to the first stop face is indicated on the marking-out aid with an appropriate optical marking.

In preferred embodiments, a plurality of first feed-through openings are present, which are disposed side by side in the main body along a first straight line. Their positions are preferably invariable and their precise distances from the first stop face are preferably represented on the marking-out aid. As a result, the marking tool, in particular the pencil, can be placed, at the desired distance of the stop face, through the opening, and the marking can in this way be applied in a simple and error-free manner.

The plurality of first feed-through openings preferably overlap one another, wherein they are configured tapered in their overlapping regions. As a result, the distances between possible marking points can be minimized They can, in particular, be smaller than the outer diameter of the marking tool. The marking tool can nevertheless be optimally held, in particular in a tiltproof manner.

Preferably, the at least one first feed-through opening has a continuous hexagonal, in particular honeycombed, cross section, which in size and shape corresponds to the cross section of a pencil. The shape and size of the at least one first feed-through opening is designed in accordance with the nature of the marking tool which is to be used.

By virtue of the thickness of the main body through which the at least one feed-through opening extends, the at least one first feed-through opening has a sufficient length to hold the marking tool in a tiltproof manner.

In preferred embodiments, at least one second feed-through opening is present, which passes through the main body, wherein it runs at a right angle to the at least one first feed-through opening and preferably parallel to the first stop face. Preferably, the at least second feed-through opening runs perpendicular to the second stop face. As a result, further markings can be applied with the same marking-out aid. The reference surface is here preferably the second stop face. Preferably, the second feed-through opening is here too labeled with a marking which shows the distance to a stop face, in particular the second stop face. The marking can, however, also relate to a diameter of a drill hole to be made, wherein the position of the feed-through opening allows for the necessary distance to an edge or corner of the structural part.

Preferably, a plurality of second feed-through openings are present, which are disposed in the main body along a second straight line, wherein the second straight line runs at an angle unequal to 90° to a longitudinal direction of the at least one first feed-through opening. In the case of the second feed-through openings too, overlaps are possible. Also the shape and size is preferably again matched to the shape and size of the marking tool.

Further embodiments are defined in the dependent claims.

### BRIEF DESCRIPTION OF THE DRAWINGS

A preferred embodiment of the invention is described below with reference to the drawings, which serve merely for illustration and should not be interpreted restrictively. In the drawings:

FIG. 1 shows a perspective representation of a marking-out aid according to the invention;

FIG. 2 shows a view of the marking-out aid according to FIG. 1 from the rear;

FIG. 3 shows a view of the marking-out aid according to FIG. 1 from above;

FIG. 4 shows a first representation of a use of the marking-out aid according to the invention according to FIG. 1, for the installation of finger protection devices on a door with door wing and door frame or casing;

FIG. 5 shows a second representation of the use according to FIG. 4;

FIG. 6 shows a third representation of the use according to FIG. 4, and

FIG. 7 shows a fourth representation of the use according to FIG. 4.

### DESCRIPTION OF PREFERRED EMBODIMENTS

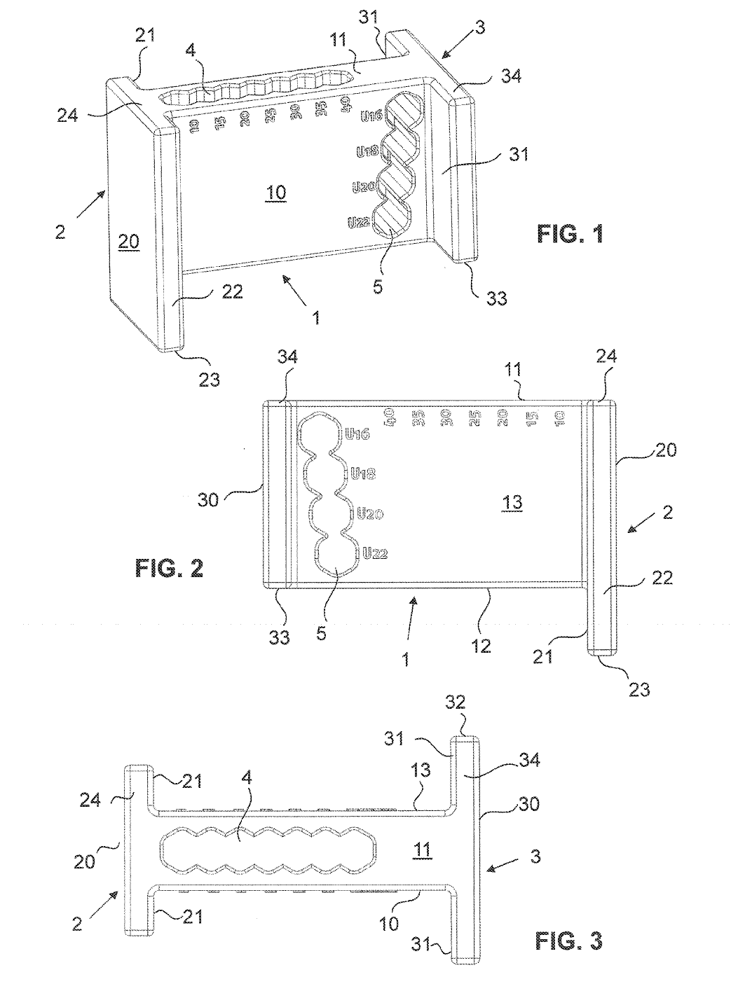

In FIGS. 1 to 3, a marking-out aid according to the invention is represented. It is configured in one piece and made, in particular, of plastic, wood or metal. It has a main body 1, a first transverse beam 2 formed onto the first end of the main body 1, and a second transverse beam 3 formed onto the second end, lying opposite the first, of the main body 1.

The main body 1 is of cuboid configuration, having a front side 10, a first end side 11, a second end side 12, and a rear side 13. All sides are configured flat. Mutually opposing sides run parallel to each other.

The two transverse beams 2, 3 are likewise of cuboid configuration. The main body 1 and the two transverse beams 2, 3, are configured relatively narrow.

The surfaces of the two transverse beams 2, 3 are likewise preferably all of flat configuration, and mutually opposing sides preferably all run parallel to each other.

The two transverse beams 2, 3 are arranged at a right angle to the main body 1, so that the cross section of the marking-out aid has the shape of a double T. The main body 1 forms the foot of the T, the two transverse beams 2, 3 the respective arms of the T. The main body 1 is preferably disposed in the middle in relation to the two transverse beams 2, 3, i.e.

the respective two arms of the respective T's of the transverse beams 2, 3 are in mirror symmetry in relation to the main body 1. The arms of the second transverse beam 3 are preferably configured longer than the arms of the first transverse beam 2.

The first transverse beam 2 has a flat face, which is facing away from the main body 1. This face form a first stop face 20. The rear side of the first transverse beam 2, which rear side is facing toward the main body 1, is provided in the figures with the reference symbol 21. Two first end sides 22 are likewise configured flat. A second end side 23 protrudes from the main body 1; i.e. the first transverse beam 2 is configured longer than the main body 1. A flat third end side 24, which lies opposite the second end side 23, is aligned with the first end side or end face 11 of the main body 1. Preferably, all these sides or faces, apart from the rear side 21 of the first transverse beam 2, can serve as stop faces.

The second transverse beam 3 is similarly configured. A side facing away from the main body 1, and a flat surface running parallel to the first stop face 20, bears in the figures the reference symbol 30. It serves as a second stop face 30. An opposite flat rear side, facing toward the main body 1, is provided in the figures with the reference symbol 31. Two first flat end sides running parallel to the front side 10 and rear side 13 of the main body serve as second stop faces 31. A flat second end side 33 is aligned with the first end side 11 of the main body 1. A flat third end side 34, lying opposite the second end side 33, of the second transverse beam 3 is aligned with the second end side 12 of the main body 1. The surfaces of the second transverse beam 3 run either parallel or perpendicular to the surfaces of the main body 1 and, apart from the rear side 31 of the second transverse beam 3, can all serve as stop faces.

In the main body 1, through openings 4, 5 for the feed-through and securement of a marking tool are present. The here represented marking-out aid is used with a pencil as the marking tool, which pencil has a hexagonal cross section. Such pencils are widespread and practically every craftsman carries one around in his pocket.

The shape and size of the feed-through openings 4, 5 are matched to the shape and size of the marking tool. In this case, they are therefore likewise hexagonal.

First feed-through openings 4 extend rectilinearly from the first end side 11 of the main body 1 through to the second end side 12. Here a plurality of first feed-through openings 4 are disposed side by side or one behind the other in a straight line, in overlapping arrangement. By virtue of their hexagonal shape, they taper in their region of overlap, so that the pencil is nevertheless held in a tiltproof manner in a single through opening.

The pencil can easily, during use, be introduced into the respective feed-through opening 4. It does not have to remain constantly mounted therein.

Second feed-through openings 5 extend from the front side 10 to the rear side 13 of the main body 1. Preferably, the second feed-through openings 5 do not pass through the first feed-through openings 4. First and second feed-through openings 4, 5 run preferably rectilinearly through the main body 1.

Here too, a plurality of second feed-through openings 5 run along a straight line. This straight line runs, however, along the front side 10, i.e. at an angle to the transverse beams 2, 3. Here too, the openings 5 overlap, and they, in turn, have a hexagonal shape or a shape matched to the marking tool.

Adjacent to the first and second feed-through openings 4, 5, data are preferably recorded, for example imprinted or engraved, on the main body 1. In this example, for the first feed-through openings 4 the distance to the first stop face 20 is indicated in mm. In FIGS. 1 and 2, the corresponding numbers 10, 15, 20, 25, 30, 35 and 40 are evident. Standing adjacent to the second feed-through openings 5 are the notations U16, U18, U20, U22. This corresponds to various product types of finger protection devices, in particular of hinge covers.

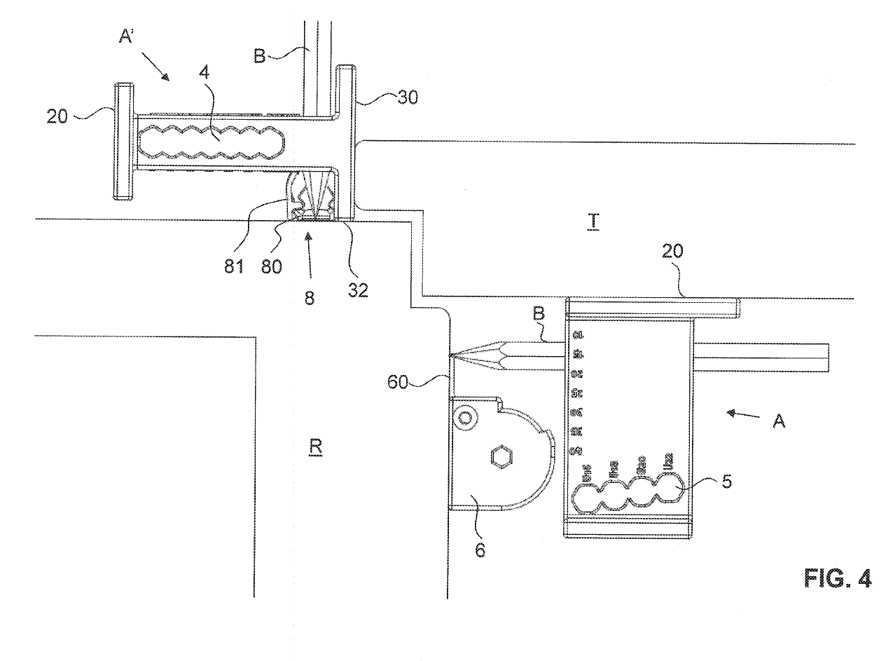

In FIGS. 4 to 7, an application example for the use of such a marking-out aid is represented. On a door is intended to be mounted, on a door frame R, a finger protection roller blind 6, 7, as well as a further finger protection in the shape of a hinge cover 8. The door wing T is here closed.

In FIG. 4, a housing 6 for the reception of a rolled-up textile roller blind is represented.

The textile roller blind is not represented in den drawings. The housing 6 has a mounting strip 60. The marking-out aid A according to the invention is placed with its first stop face 20 of the first transverse beam 2 against the closed door wing T. The marking tool, here a pencil B, is stuck through one of the first feed-through openings 4 and can thus serve to mark the position of the front edge of the mounting strip 60. Here, the desired distance to the door wing amounts to 15 mm. Furthermore, the marking tool B, even without the position of the marking-out aid being altered, can be removed and newly fed through another feed-through opening so as to apply a further marking, for example the position of a drill hole. This process can be repeated as often as is wished.

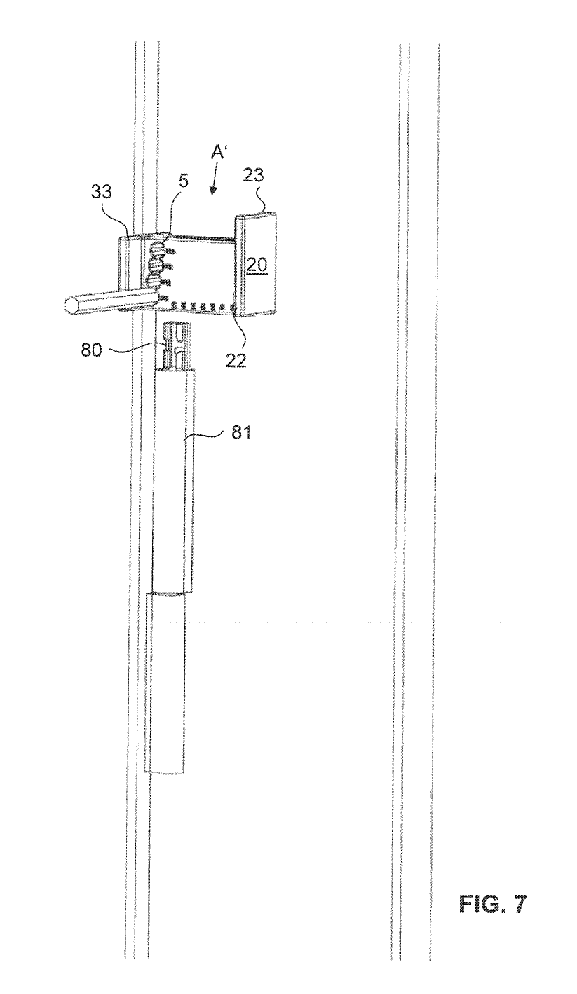

Likewise in FIG. 4, the marking-out aid according to the invention, here provided with the reference symbol A′, serves for the positioning of the hinge cover 8. The hinge cover 8 represented in this example has one or more clamps 80, onto which a protective profile 81 can be mounted. The marking-out aid A′ is placed with the second stop face 30 against the closed door wing T, and with the third stop face 32 of the second transverse beam 3 against the door frame R. The pencil B is stuck through one of the second feed-through openings 5, so that the desired distance of the drill hole to the corner, formed by door wing T and door frame R, can be noted. Since the arms of the first transverse beam 2 are configured shorter than those of the second transverse beam 3, in this type of marking they do not get in the way. This use of the marking-out aid A′ is also represented in FIG. 7.

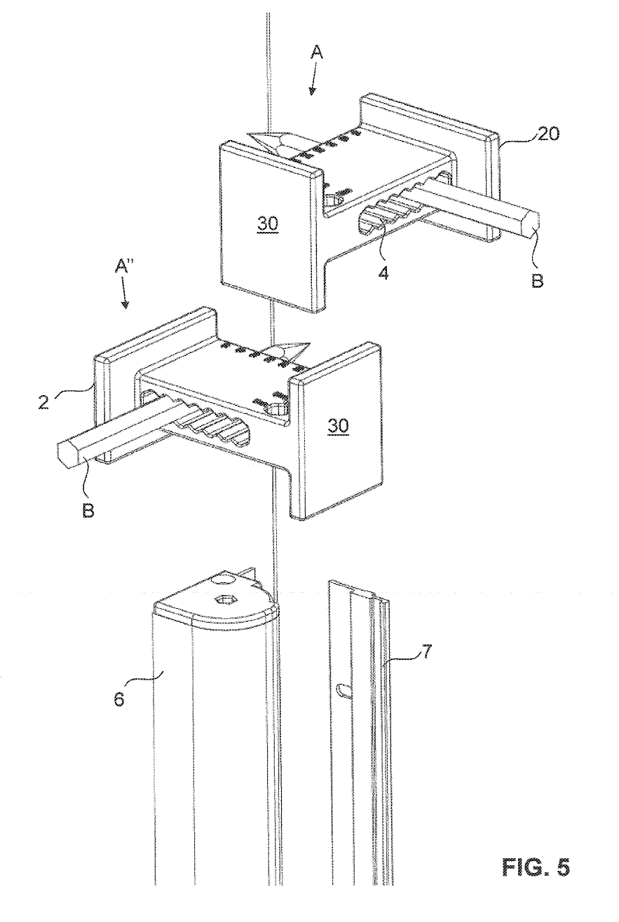

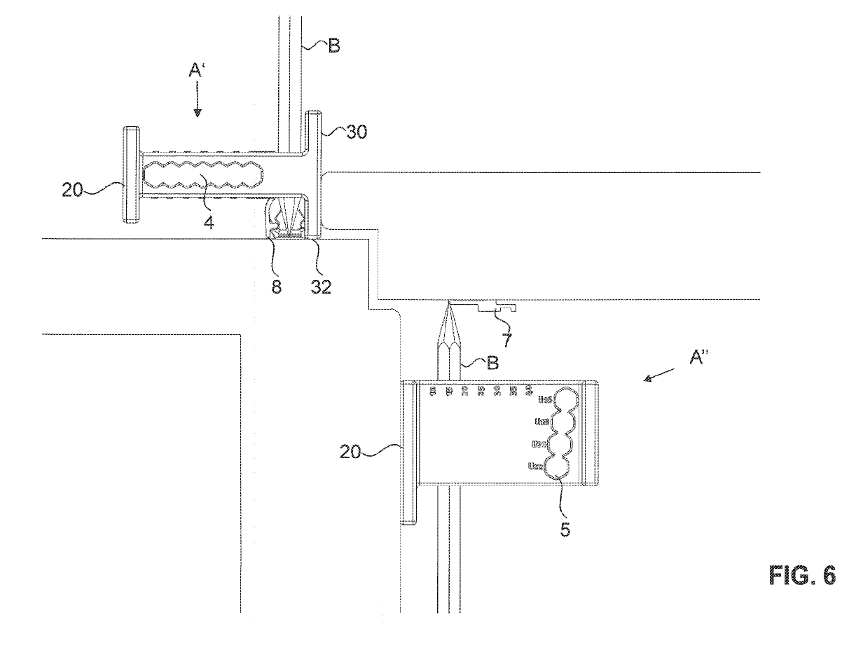

In FIG. 5, the marking for the positioning of the housing 6 is once again represented, wherein the marking-out aid A is used for this purpose. The marking-out aid A″ serves for the positioning of a hanging rail 7 of the finger protection roller blind (not represented here). This hanging rail 7 is fastened to the door wing T and serves for the hanging of the textile roller blind. As is clearly evident in FIG. 6, marking is made, here too, with closed door wing T. The marking-out aid A″ now bears with the first stop face 20 of the first transverse beam 2 against the door frame T, and the pencil B is, in turn, fed through a desired first feed-through opening 4.

The here represented marking-out aids A, A′, A″ are always constituted by the same marking-out aid, which is used successively for the positioning of the individual elements of the finger protection devices. It is thus very flexibly and universally usable. It can be used, in particular, also for differently designed finger protection devices, or for the positioning or marking of other elements or structural parts.

1. A marking-out aid for applying an installation marking to an object, in particular a building element, wherein the marking-out aid has at least one stop face for the defined contact of the marking-out aid against the object, and at least one first feed-through opening for receiving a marking tool, wherein the marking-out aid has a main body and a first transverse beam, in that the at least one first feed-through opening passes through the main body, wherein the first transverse beam is disposed at a first end of the main body and runs at a right angle to the main body, wherein the first transverse beam projects beyond the main body on at least one side, and wherein the first transverse beam forms with its side facing away from the main body a first stop face of the at least one stop face.

2. The marking-out aid as claimed in claim 1, wherein the first transverse beam projects beyond the main body on at least two sides, whereby it forms a base which is widened in relation to the main body.

3. The marking-out aid as claimed claim 1, wherein the main body is of substantially cuboid configuration and has a front side, a rear side and two end sides.

4. The marking-out aid as claimed in claim 3, wherein the first transverse beam projects beyond the front side and the rear side of the main body.

5. The marking-out aid as claimed in claim 3, wherein the first transverse beam projects beyond one of the two end sides of the main body.

6. The marking-out aid as claimed in claim 1 wherein, in addition to the first stop face at least one further stop face is, wherein the main body has a second end lying opposite the first end, wherein a second transverse beam is disposed at the second end of the main body and runs at a right angle to the main body and parallel to the first transverse beam, wherein the second transverse beam projects beyond the main body on at least one side, and wherein the second transverse beam forms at least one of the further stop faces.

7. The marking-out aid as claimed in claim 3, wherein in addition to the first stop face at least one further stop face is, wherein the main body has a second end lying opposite the first end, wherein a second transverse beam is disposed at the second end of the main body and runs at a right angle to the main body and parallel to the first transverse beam, wherein the second transverse beam projects beyond the main body on at least one side, and wherein the second transverse beam forms at least one of the further stop faces and wherein the second transverse beam projects beyond the front side and the rear side of the main body, whereby it forms a base which is widened in relation to the main body.

8. The marking-out aid as claimed in claim 6, wherein the second transverse beam has a flat side, which is facing away from the main body and which forms a stop face of the at least one further stop face.

9. The marking-out aid as claimed in claim 6, wherein the second transverse beam has at least one flat end side, which forms a stop face of the at least one further stop face.

10. The marking-out aid as claimed in claim 6, wherein the first and the second transverse beam each have an end side, which end sides are aligned with each other and jointly with an end side of the main body and form a flat fourth stop face.

11. The marking-out aid as claimed in claim 1, wherein the at least one first feed-through opening runs parallel to the first stop face and between two surfaces, running perpendicular to the first stop face, of the main body.

12. The marking-out aid as claimed in claim 11, wherein a plurality of first feed-through openings are present, which are disposed side by side in the main body along a first straight line.

13. The marking-out aid as claimed in claim 12, wherein the plurality of first feed-through openings overlap one another, wherein they are configured tapered in their overlapping regions.

14. The marking-out aid as claimed in claim 1, wherein at least one second feed-through opening is present, which passes through the main body, wherein it runs at a right angle to the at least one first feed-through opening.

15. The marking-out aid as claimed in claim 14, wherein a plurality of second feed-through openings are present, which are disposed in the main body along a second straight line, wherein the second straight line runs at an angle unequal to 90° to a longitudinal direction of the at least one first feed-through opening.

16. The marking-out aid as claimed in claim 1, wherein the marking-out aid is configured in one piece.
